(19) United States
(12) Patent Application Publication
(10) Pub. No.: US 2021/0361983 A1
(43) Pub. Date: Nov. 25, 2021

(54) ACTIVE RESPIRATORY FILTRATION SYSTEM

(71) Applicant: Michael J. Piatt, Springboro, OH (US)

(72) Inventor: Michael J. Piatt, Springboro, OH (US)

(21) Appl. No.: 17/323,697

(22) Filed: May 18, 2021

Related U.S. Application Data
(60) Provisional application No. 63/027,911, filed on May 20, 2020.

(51) Int. Cl. A62B 18/00; A62B 18/02

(52) U.S. Cl. CPC A62B 18/006; A62B 18/025

(57) ABSTRACT

An active respiratory filtration system that provides a continuous flow of filtered air to a face mask, covering the nose and mouth of the user. The forced air is directed into the inner volume of the face mask, creating a positive pressure which yields several advantages, including: reducing user inhalation, reducing heat built-up within the face mask's inner volume, help overcome face mask perimeter seal breach issues. Some embodiments include the use of pliable mask filters, enabling the filtration of exhalation air from the user to the environment, thereby protecting others. Other embodiments include at least one check valve integrated into the face mask, thereby reducing the user exhalation effort. The system is configured to be compact, light-weight and portable.

### PRIORITY CLAIM AND RELATED APPLICATIONS

This non-provisional application claims the benefit of priority from provisional application U.S. Ser. No. 63/027,911 filed on May 20, 2020. Said application is incorporated by reference in its entirety.

### BACKGROUND OF THE INVENTION

### 1. The Field of the Invention

The present invention relates to respiratory protective face mask systems. More specifically, the present invention is directed to face mask systems comprising one or more portable air pumps to provide filtered air to the user.

### 2. Background Art

Respiratory protective masks are an essential part of disease prevention for first responders, medical professionals and the like. For such workers, protection against pathogenic type of microorganisms is of primary importance. Additionally, respiratory protective masks also find utility in a multitude of non-medical settings, including environments having or suspected to contain undesirable airborne contaminants, such as particulate type of pollutants. Such non-medical or utility settings include, but not limited to: construction sites, farming sites, industrial environments and the like. Protection from particulate type of impurities, e.g., dust, dirt, smoke and the like, are typically sought in such non-medical or industrial settings.

In medical settings, the preferred type of face mask protects both the individual wearing the face mask (the user) and others in the environment, proximate to the user. To enable such dual protection, the user's face mask system must not only filter the inhalation air consumed by the user, but additionally, filter the exhalation air exhausted by the user to protect others. When a user dons a typical passive face mask, there is a marked increase in face mask inhalation and exhalation resistance experienced by the user. This increased burden tends to fatigue the user the longer the user wears the face mask. Regarding passive type face masks, the increase in the burden is inherent to the device. This produces unnecessary fatigue for use in non-medical situations, since filtration of exhalation air is typically not required.

Over the years, mask technology has evolved and standards have been established to quantify their performance and assure consistency in manufacturing. The OSHA N95 designation is a common respiratory type of face mask, which when worn properly, filters both the user's inhalation and exhalation air. Such face masks typically use nonwoven materials to trap about 95% of the particles and moisture droplets entering and exiting the membrane of a size of 0.3 microns or larger. For this exemplary face mask to be effective, it is essential that an effective seal be made with the user. This can lead to considerable discomfort over time, causing irritation and soreness over the contact areas. Again, the masks can be difficult to breathe through, having a pressure drop of over 0.5 inch of water across a typical filtration membrane and the internal volume of such masks typically overheats and contains excess moisture caused by the lack of adequate air circulation, leading to additional user discomfort. These disadvantages are tolerated because of the demonstrated value provided by the mask. More sophisticated systems, typically available in hospital settings, provide additional comfort and involve pumping filtered air into enclosed volumes around the user's head. They are typically connected through a hose to a central air source. Although highly effective, they limit mobility to the length of the air hose and are not practical for emergency situations where substantial mobility is required.

In the respiratory face mask arts, it's clear that there exists a need for reducing the burden associated with the additional effort required to inhale and exhale while wearing passive respiratory type face masks.

### SUMMARY OF THE INVENTION

The present disclosure delineates an active respiratory filtration system directed to providing a hygienic barrier between a user and the user's proximate surroundings. Other exemplary embodiments additionally provide others, in the user's proximate environment, hygienic or respiratory protection from the user. Presented are disclosures of face masks and methods of use that overcome the aforementioned disadvantages of well-known personal filtration devices and systems.

Accordingly, it is an object of the present invention to provide an active respiratory filtration system (ARFS) configured such that the system components are supported by a head harness. The system comprises at least one portable power source to enable mobility.

It is another object of present invention to provide a filtration system module attached to the rear portion of the head harness. The filtration system module (FSM) comprises at least one air pump, at least one rear filter, at least one control system and an air transport enclosure system. The FSM is configured to be compact and lightweight to promote transportability.

It is yet another object of certain embodiments of present invention to provide a face mask functionally attached to the front portion of the head harness in order to cooperate with the FSM. In certain embodiments, the face mask portion is substantially fabricated from a filtering material, e.g., pathogenic filtering material, a particulate contaminant filtering material. In other embodiments, where the user's environment does not contain other individuals, the use of a filtering material is optional and the addition of at least one check valve disposed on the face mask will permit low resistance, unfiltered venting of user exhalation air to surrounding environment.

It is a further object of the present invention to provide positive air pressure into the internal volume of the face mask in order to substantially prevent environmental contamination, e.g., particulate matter, microorganisms and the like, from entering via gaps in the face mask system. There are many causes for undesired gaps in a typical face mask system, including: incomplete engagement or bonds between interfacing materials, filtration material tears or other defects, face mask-user interface issues, improper face mask sizing and the like; which all lead to an increased risk of environmental contamination compromising the face mask filtration system.

It is another object of certain embodiments of present invention to provide a face mask system where the face mask's inner volume creates an air permeable, yet, sufficiently sealed environment, so to enable an air pump to produce a positive pressure within the inner volume of the face mask, enabling the user to easily breathe the volume of filtered air delivered.

It is yet another object of the present invention to provide the filter material portion of the system's face mask that is comprised of at least one layer of filtration fabric. Additional filtration layers can be added in order to enhance filtration capabilities to predetermined performance levels.

It is a further object of the present invention to provide air transport enclosures which are generally rectangular, configured to minimize air flow resistance and tightly engage the face mask, thereby providing a more compact system.

It is yet another object of certain embodiments of present invention to provide an FSM having at least one rear filter, which functions to provide filtered air to the inner volume of the face mask. The predetermined filtration requirements for the filtered air delivery to the user will determine the type of filter or filter material best suited to function as a rear filter. There are a multitude of filter types or filter materials to select from, which include, but not limited to: pathogenic filtering type materials, a large particulate filtering materials, HEPA certified materials, N95 capable materials and the like. Composite filters comprising two or more layers of various filtering materials can be configured to improve air filtration performance.

It is another object of this invention to provide a relatively simple system that is economical from the viewpoint of the manufacturer and consumer, is susceptible to low manufacturing costs with regard to labor and materials and which accordingly evokes low prices for the consuming public, thereby making it economically available to the buying public.

Whereas there may be many embodiments of the present invention, each embodiment may meet one or more of the foregoing recited objects in any combination. It is not intended that each embodiment will necessarily meet each objective.

Thus, having broadly outlined the more important features of the present invention in order that the detailed description thereof may be better understood and that the present contribution to the art may be better appreciated, there are, of course, additional features of the present invention that will be described herein and will form a part of the subject matter of this specification.

In this respect, before explaining at least one embodiment of the invention in detail, it is to be understood that the invention is not limited in its application to the details of construction and the arrangements of the components set forth in the following description or illustrated in the drawings. The present invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent construction insofar as they do not depart from the spirit and scope of the conception regarded as the present invention.

### BRIEF DESCRIPTION OF THE DRAWINGS

The ensuing detailed description section makes reference to the annexed drawings. An enhanced understanding of the present invention will become evident when consideration is given to the detailed description thereof and objects other than the aforementioned become apparent. The invention will be described by reference to the specification and the annexed drawings, in which like numerals refer to like elements and wherein:

FIG. 1 illustrates a general system view of an active respiratory filtration system (ARFS) including a check valve which permits unaltered or unfiltered venting of the user's exhalation air to the surrounding environment.

FIG. 2 illustrates a system view of a face mask configuration including a face mask comprising a filter material for protecting the user and others.

FIG. 3 illustrates a front view of an ARFS affixed to a user.

FIG. 4 illustrates a front view of the face mask portion of the system shown in FIG. 3.

FIG. 5 illustrates a detailed view of the internal portion of the face mask shown in FIG. 4

FIG. 6 illustrates a front view of an ARFS including exhalation check valves.

FIG. 7 illustrates a front detailed view of the face mask shown in FIG. 6.

FIG. 8 illustrates a detailed internal view of the face mask shown in FIG. 7.

FIG. 9 illustrates a side perspective view of an ARFS including a filter system module (FSM).

FIG. 10 illustrates a perspective side view of an ARFS affixed to a user.

FIG. 11 illustrates a perspective view of an FSM.

FIG. 12 illustrates a perspective front view of a streamlined ARFS embodiment comprising rectangular ducts.

FIG. 13 illustrates a perspective side view of a streamlined ARFS embodiment comprising rectangular ducts.

FIG. 14 illustrates a perspective rear view of a streamlined ARFS embodiment comprising rectangular ducts.

### SPECIFICATION DEFINITIONS OF TERMS

The active respiratory filtration system (ARFS) discussed throughout this disclosure shall have equivalent nomenclature, including, but not limited to: the device, the mask, the unit, the face mask system, the mask system, the system, the ARFS, the present invention, or the invention. Additionally, the term “exemplary” shall possess a single meaning throughout this disclosure; wherein the sole meaning is directed to serving as an example, instance, or illustration. The term “others” or “bystanders” shall be defined as individuals within the proximate or immediate environment of the user, having a reasonable probability of receiving airborne pathogens transmitted from the user.

### PARTS LIST

1—rear filter
2—unfiltered air (taken from the user's immediate environment)
4—downstream (indicator of air flow)
6—air pump (fan, fans, etc.)
8—check valve (prevents backflow of user exhalation air into the air pump)
10—filtered air
12—face mask (user protection configuration, without check valves 14)
14—check valve (vents unfiltered user's exhalation air into surrounding environment)
15—control system
16—air transport enclosure system (ATE)
18—exhalation air (unfiltered air vented from user)
20—face mask (configuration for protecting user and others)
22—filtered exhalation air (passes through face mask filter material)
24—active respiratory filtration system (ARFS), without exhalation check valves
26—user
28—nose clip
30—ear loops (right & left ear loops helps support ARFS)
32—face mask (without exhalation check valves)
34—filter material (filters user's exhalation air)
36—air transport enclosure (ATE), round hose type of embodiment
38—face mask connector (right and left units)
40—slide-on receiver (configured for round hose ATE embodiments)
42—front portion (subset of complete head harness 56)
44—user seal (engages perimeter about user's mouth and nose)
46—inner volume (of face mask 32)
47—input port—back view (for filtered air 10)
48—face mask (exhalation check valves included)
50—check valves—back view (right and left, for venting user exhalation air)
52—filter system module (FSM)
54—rear portion (subset of total head harness 58)
56—head harness
58—back strap
60—battery (power source)
62—control board (subset of FSM 52)
64—rear filter
66—streamlined embodiment
68—rectangular ducts

### Particular Advantages of the Invention

The present invention provides cost-effective, efficient solutions directed to the disadvantages associated with passive types of face masks. Such face masks are configured to provide a hygienic barrier between the user and the user's external environment. One focus of the present invention is to reduce the burden placed on the user, associated with the additional effort required to inhale and exhale while wearing a passive respiratory type face mask. The additional effort is associated with the increased resistance to airflow presented by the mask's filter media. The present invention provides an active means for producing and delivering filtered air to the user, thereby eliminating the need for the user to expend the additional energy required to pull outside air through the mask's filter media. An additional advantage of having an externally powered source of filtered air to the user, is that the positive pressure produced in the face mask, prevents outside contaminates from entering through gaps in the face mask seal and the like. Additionally, the airflow within the internal volume of the face mask reduces the heat and moisture buildup, enhancing user comfort. Another aspect of the present invention is directed to typical non-medical face mask applications where filtration of exhalation air from the user is not required; a low resistance means for exhausting user exhalation air is yet another disclosed advantage.

### DETAILED DESCRIPTION

With reference to the drawings of the present invention, several embodiments pertaining to the faucet system of the present invention thereof will be described. In describing the embodiments illustrated in the drawings, specific terminology will be used for the sake of clarity. However, the invention is not intended to be limited to the specific terms so selected and it is to be understood that each specific term includes all technical equivalents that operate in a similar manner to accomplish a similar purpose. Terminology of similar import other than the words specifically mentioned above likewise is to be considered as being used for purposes of convenience rather than in any limiting sense.

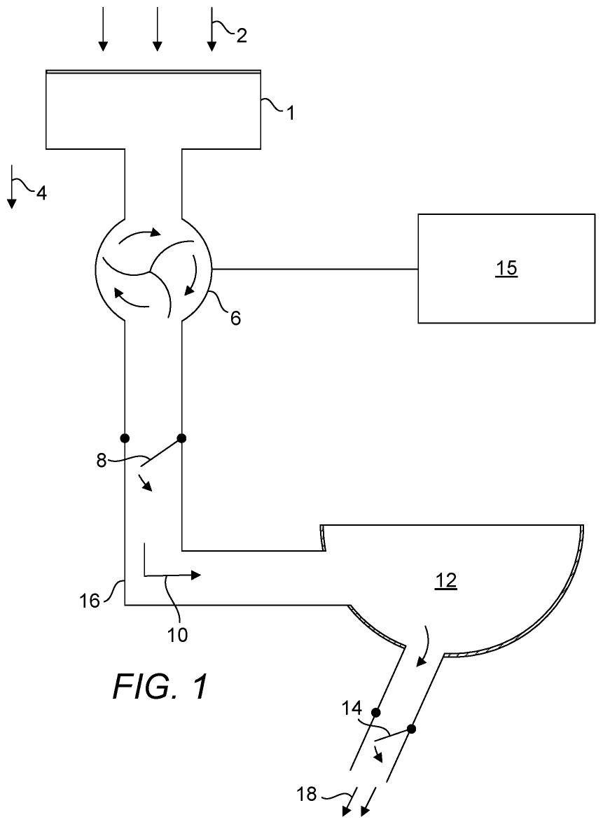

FIG. 1 illustrates a general system view of an active respiratory filtration system (ARFS). Unfiltered air 2, taken from user's 26 immediate environment and is drawn through rear filter 1 by air pump 6, producing filtered air 10. Filtered air 10 is moved in downstream 4 direction through air transport enclosure system 16 into the inner volume of face mask 12. The present embodiment also includes check valve 14 which permits unfiltered expulsion of user exhalation air 18 to the surrounding environment. An optional backflow check valve 8 prevents user's 26 exhalation air 18 from flowing in a counterproductive, upstream direction toward air pump 6.

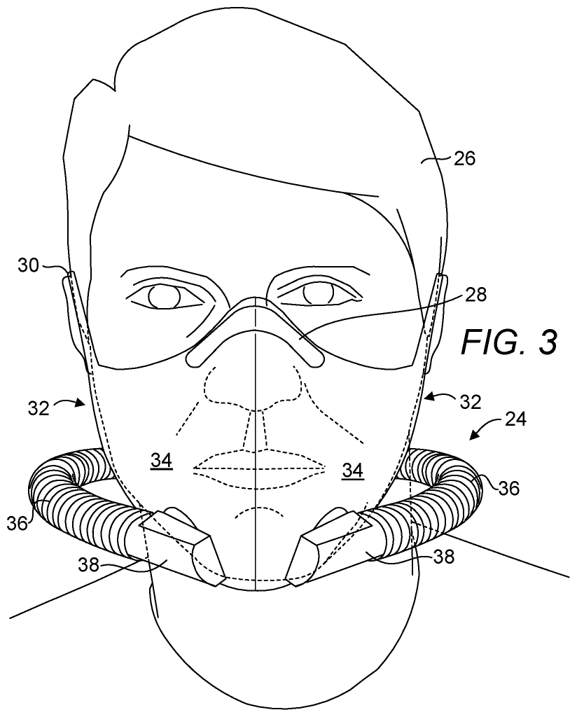

Air pump 6 is managed by control system 15, which is comprised of a portable power source, such as a battery pack. Other exemplary components include, but not limited to a charging port for use with rechargeable battery systems, a battery health or charge level indicator and a power management subsystem to control electrical power to air pump 6, for controlling the velocity of filtered air 10 through air transport enclosure system 16. The embodiment depicted in FIG. 1 is configured to substantially protect user 26, shown in FIG. 3, from the possible contaminates contained in unfiltered air 2. Check valve 14 allows the unaltered or unfiltered venting of user exhalation air 18 to the surrounding environment, which reduces the exhalation effort required by the user when compared to exhaling through a filter media. The use of check valve 14 should only be considered in situations where the user does not pose a potential hygienic or health hazard to others.

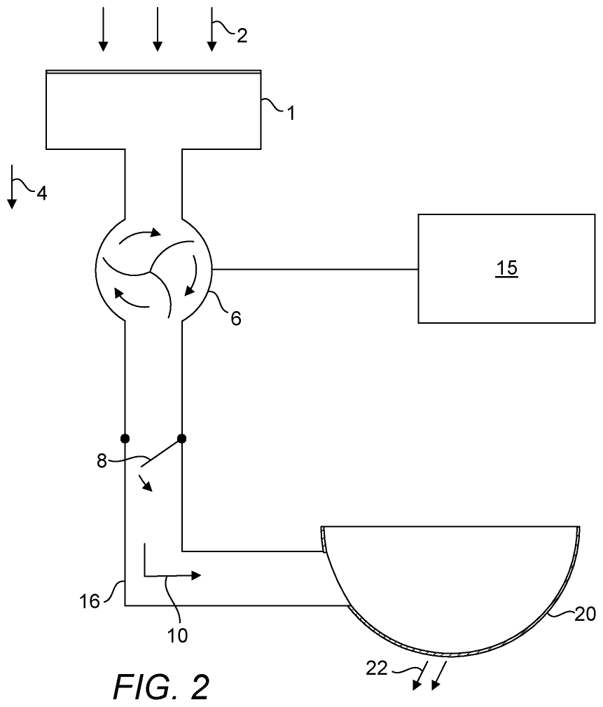

FIG. 2, in cooperation with the previous review of general system view of FIG. 1, delineates an ARFS without a means for exhausting user unfiltered exhalation air, i.e., check valve 14 was never configured as a part of face mask 20. Instead, face mask 20 is comprised of a filter material such that the user's exhalation air is filtered as it exits through face mask 20, thereby exhausting filtered exhalation air 22 into the environment. This configuration provides an exemplary embodiment where both the user and others are protected.

FIG. 3 illustrates a front view of an ARFS 24 affixed to user 26. This embodiment is configured without exhalation check valves 14, but includes face mask 32 comprising filter material 34, such that user's 26 exhalation air 18 is filtered as it exits face mask 32, into the environment. Further illustrated are right and left face mask connectors 38 which function to direct filtered air 10 into inner volume 46 of face mask 32 via air transport enclosure (ATE) 36. Nose clip 28 is configured to conform to the top portion of user's 26 nose and provides enhanced sealing and additional support. Both right and left ear loops 30 are configured to supportingly engage with user's 26 corresponding right and left ears respectively.

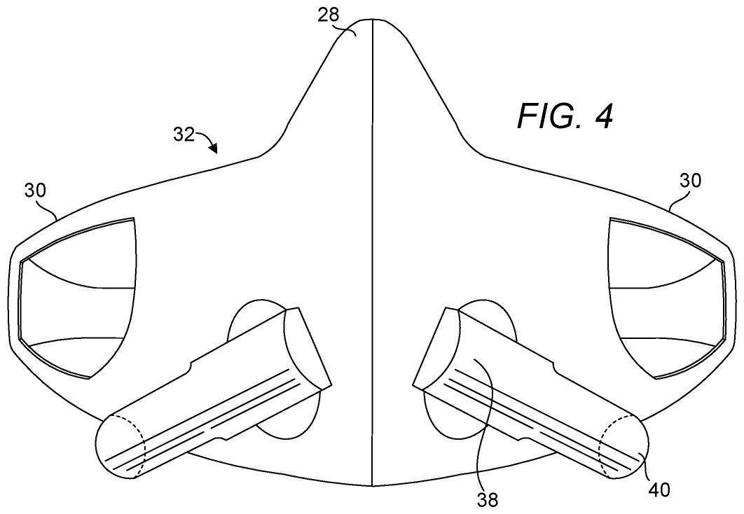

FIG. 4 illustrates a detailed front view of face mask 32 shown in FIG. 3. Clearly depicted are right and left ear loops 30 support members. Right and left face mask connectors 38 further comprise slide-on receiver 40, configured for receiving an air transport enclosure system 16 having a round hose type of configuration. The exemplary configuration including quick-connect features, such as slide-on receiver 40 and the like, enable the depicted round hose type of air transport enclosure system 16 to be easily attached, as well as disassembled for inspection, cleaning/sterilization, reuse, recycling, disposal, or any combination thereof.

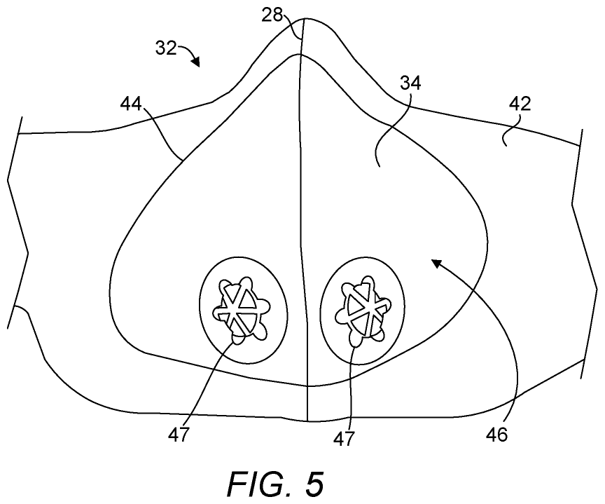

FIG. 5 illustrates a detailed internal view of the face mask 32 shown in FIG. 4. Depicted is inner volume 46 of face mask 32 having filter material 34 disposed on front portion 42 of head harness 56. Filter material 34 further includes a user seal 44 which is configured to sealingly engage about the perimeter of the nose and mouth areas of user 26, thereby substantially forming inner volume 46 enclosure. Right and left input ports 47 are designed to allow filtered air 10 into inner volume 46, enabling the creation of a positive pressure environment within inner volume 46.

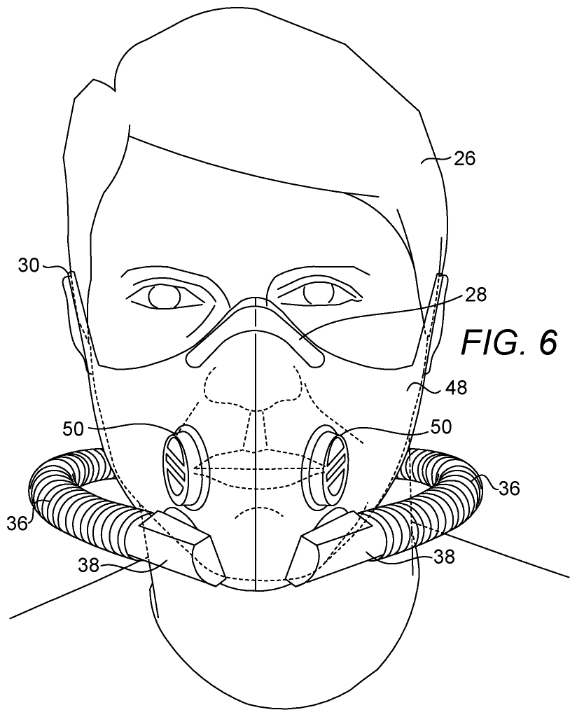

FIG. 6 illustrates a front view of another ARFS embodiment, similar to ARFS 24 affixed to user 26 shown in FIG. 3, except the present embodiment includes exhalation check valves 50. This embodiment is configured with right and left exhalation check valves 50 attached to face mask 48. Alternate embodiments of face mask 48 can be fabricated from materials that do not provide any means for the filtering of air. Such embodiments are possible because user's 26 exhalation air 18 is exhausted via right and left exhalation check valves 50, directly into the surrounding environment. Such face mask 48 alternate embodiments can be comprised of transparent materials, for better viewing of the user 26.

Face mask 48 can optionally be configured to be air permeable, yet the material must present an adequate amount of air resistance so to enable air pump 6 to produce a positive pressure within the inner volume 46, while enabling user 26 to consume the volume of filtered air 10 delivered. The present embodiment offers user 26 a low exhalation air resistance option, which reduces the onset of user fatigue. This embodiment is configured to serve in applications where user 26 seeks protection from their surrounding environment and ideally, others are not present in the surrounding environment, proximate to the user.

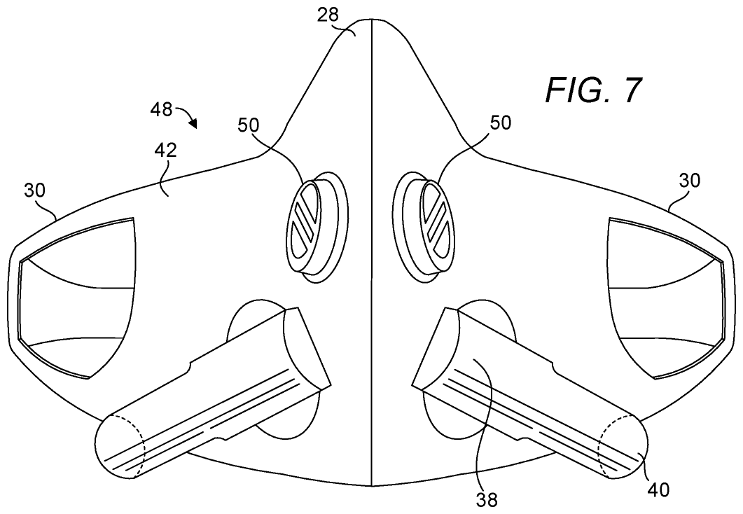

FIG. 7 illustrates a detailed front view of the face mask 48 shown in FIG. 6. FIG. 7 illustrates a similar embodiment as shown in FIG. 4, with the exception of the inclusion of right and left check valves 50. Depicted are right and left ear loops 30 support members. Right and left face mask connectors 38 each having slide-on receiver 40, configured for an air transport enclosure system 16 having a round hose type structure. The exemplary configuration utilizing a slide-on receiver 40 and the like, enables quick-connect options for depicted round hose type of air transport enclosure system 16, streamlining system assembly/disassembly, often required for component inspection, cleaning/sterilization, reuse, recycling, disposal, or any combination thereof.

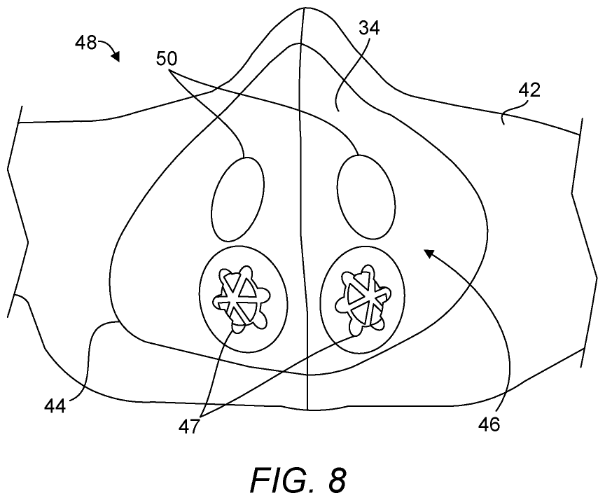

FIG. 8 illustrates a detailed internal view of the face mask 48 shown in FIG. 7. FIG. 7 illustrates a similar embodiment depiction shown in FIG. 5, with the exception of right and left check valves 50. Depicted is inner volume 46 of face mask having filter material 34 disposed on the front portion 42 of head harness 56. Filter material 34 further includes a user seal 44 which is configured to sealingly engage about the perimeter of the nose and mouth areas of user 26, thereby substantially forming inner volume 46. Right and left input ports 47 are designed to allow filtered air 10 into inner volume 46, as well as providing a positive pressure environment within inner volume 46. In the present embodiment, right and left check valves 50 are correspondingly disposed above right and left input ports 47. Again, right and left check valves 50 provides user 26 a low resistance exhalation option, reducing the onset of user fatigue. This embodiment is configured to serve in applications where user 26 seeks protection from their surrounding environment and ideally, others are not present in the surrounding environment, proximate to the user.

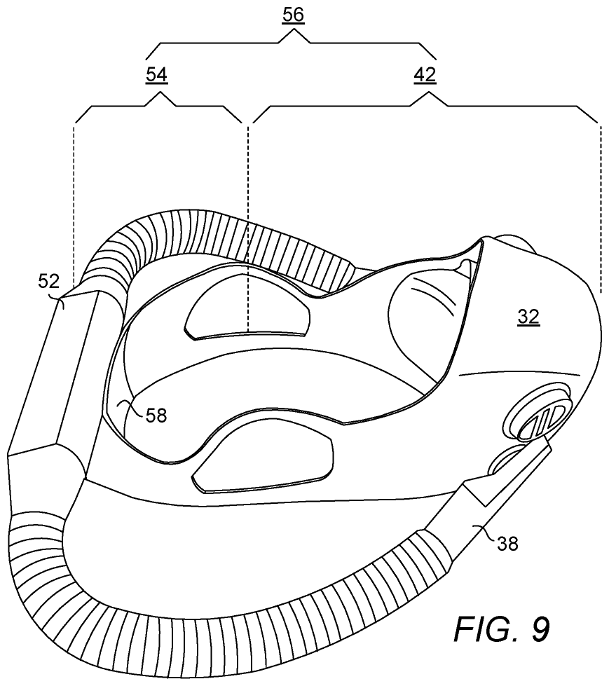

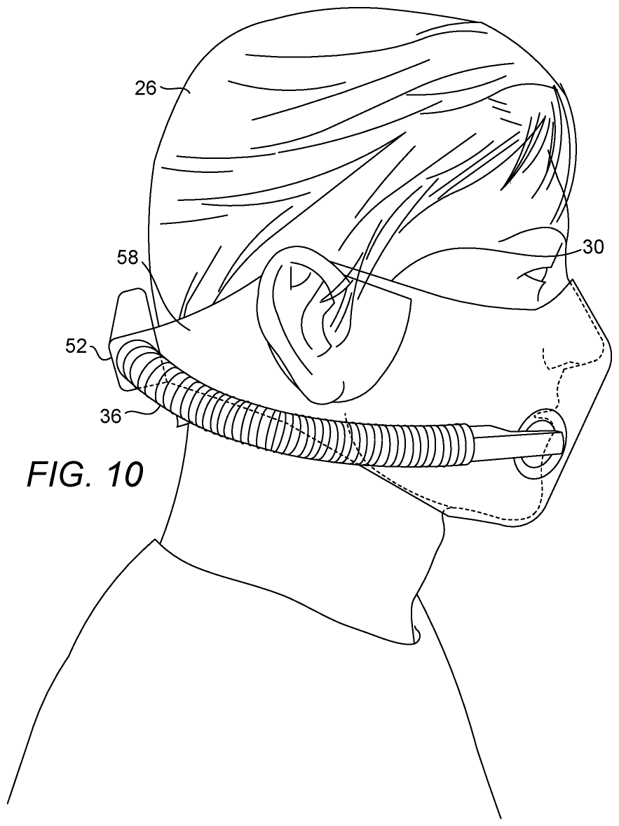

FIGS. 9 and 10 illustrate side perspective and side views, respectively, of a complete exemplary ARFS, further depicting filter system module (FSM) 52. The ARFS is organized and supported on head harness 56, which is configured to securely attach to user's 26 head. Head harness 56 further comprises back strap 58 which optionally includes a quick-connect means, enabling the separation of the strap into two sections to expedite attaching and/or removal of ARFS to user 26; as well as expediting disassembly of ARFS components for service, repair, cleaning and the like.

Head harness 56 is comprised of two contiguous primary sections, i.e., front portion 42 and rear portion 54. Rear portion 54 includes back strap 58, which provides support for FSM 52. Front portion 42 comprises face mask 32 or face mask 48 depending on the embodiment. In exemplary embodiments, disposed between front portion 42 and rear portion 54, include a pair of right and left ear loops 30, configured to help support ARFS by engaging the ears of user 26.

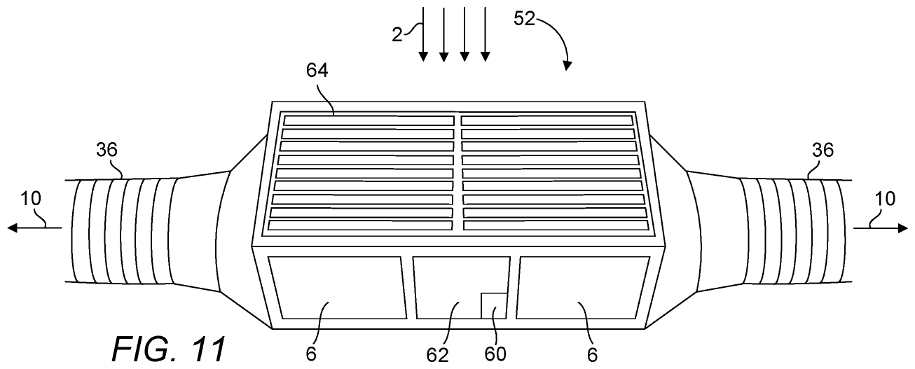

FIG. 11 illustrates a perspective view of an FSM 52. FSM 52 is affixed to back strap 58. FSM 52 is comprised of a plurality of subsystems or components which are strategically configured to functionally interconnect to be compact and lightweight for ease of transportability. FSM 52 is comprised of at least one rear filter 64, selected to perform at a predetermined level of filtration performance. Below rear filter 64 are right and left air pumps 6, which draw unfiltered air 2, taken from the user's 26 immediate environment and drawn through rear filter 64. The resulting filtered air 10 is directed to right and left ATE-hoses 36, which is transported to the face mask located on the front portion 42 of head harness 56. FSM 52 further comprises a power source battery 60 of sufficient capacity to power the complete active respiratory filtration system for a reasonable amount of time. Exemplary power sources include high capacity, compact, rechargeable battery systems, including battery health indicators, chargers and corresponding connectors and the like.

Exemplary FSM 52 also includes control system 15 (shown in FIGS. 1 and 2), which manages at least one air pump 6 managed by control system 15. Other exemplary control system 15 features include, but not limited to a power management subsystem to control power delivery to air pump 6 for controlling the velocity of filtered air 10 through air transport enclosure system 36 into corresponding face mask. In preferred embodiments, to enhance safety, the FSM further includes redundant components, to protect against component failures. Redundant components include but are not limited to the following components: air pump, rear filter, control system and battery.

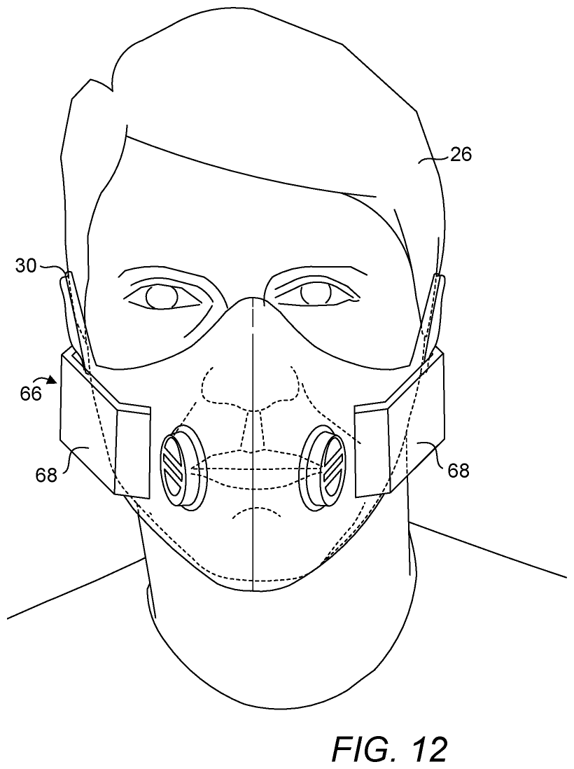

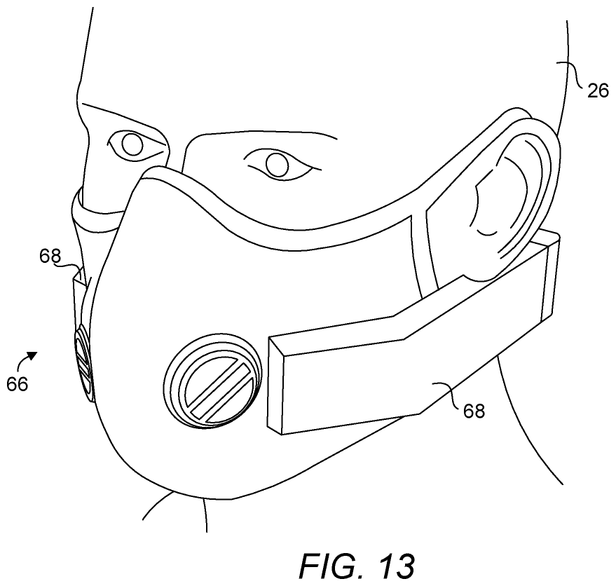

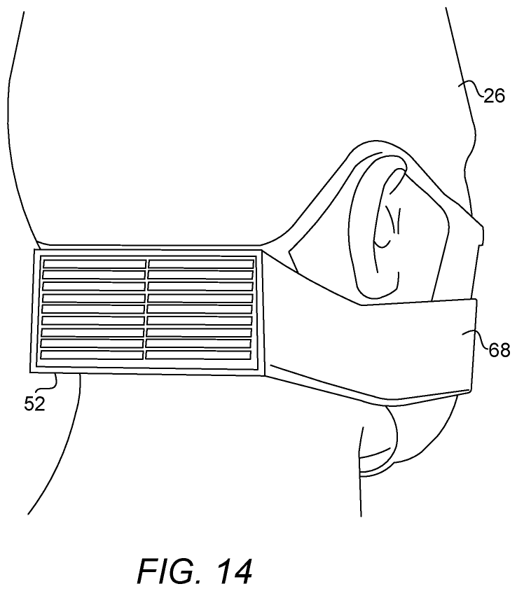

FIGS. 12, 13 and 14 illustrate respective front, side and rear perspective views of a streamlined ARFS 66 embodiment. ARFS 66 comprises right and left rectangular ducts 68. Rectangular ducts 68 are configured to provide a more compact, user friendly system. In one aspect, the dimensions of rectangular ducts 68 are selected to maximize airflow, while reducing the width of the duct. An exemplary embodiment of such a design is shown FIGS. 12, 13 and 14, where rectangular ducts 68 are elongated in the vertical direction, thereby reducing the overall width and streamlining the overall appearance of ARFS 66 embodiment.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

What is claimed herein is:

1. An active respiratory filtration system for providing a hygienic barrier between a user and the user's proximate surroundings having a volume of unfiltered air, said active respiratory filtration system comprising a harness adapted to engage with the user's head, said harness comprising:
(a) a rear portion comprising a filtration system module attached thereon, said filtration system module further comprising:
(b) (i) an air pump for moving the volume of unfiltered air through a rear filter, so to produce a delivery of filtered air; and
(c) (ii) a control system functionally connected to said air pump for controlling said delivery of filtered air, said control system further comprising a power source for motivating said air pump; and
(d) (iii) an air transport enclosure system configured for directing flow of said delivery of filtered air exiting from said filtration system module; and
(e) a front portion, comprising a face mask attached thereon, said face mask configured from a filter material, said face mask comprising:
(f) (i) an inner volume and an outer surface; and
(g) (ii) at least one face mask connector disposed on said outer surface configured to fluidly engage with said air transport enclosure system, so to direct said delivery of filtered air from said filtration system module to said inner volume of said face mask.

2. The active respiratory filtration system of claim 1, wherein said face mask receives said delivery of filtered air so to produce a positive pressure environment within said inner volume of said face mask, thereby reducing the risk of environmental contamination via face mask gaps or defects.

3. The active respiratory filtration system of claim 1, wherein said face mask further comprises at least one check valve for enabling the unfiltered venting of the user's exhalation air from said inner volume of said face mask, thereby circumventing said filter material, resulting in a reduction in exhalation effort.

4. The active respiratory filtration system of claim 1, wherein said air transport enclosure system further comprises at least one check valve disposed therein, configured to prevent backflow of the user's exhalation air.

5. The active respiratory filtration system of claim 1, wherein said rear filter and said face mask is fabricated from a material selected from the group consisting of a pathogenic filtering material, a particulate contaminant filtering material, a HEPA certified material and any combination thereof.

6. The active respiratory filtration system of claim 1, wherein said air pump is disposed downstream of said rear filter, whereby said air pump receives said delivery of filtered air.

7. The active respiratory filtration system of claim 1, wherein said control system is configured to manage a power delivery to said air pump, wherein magnitude of said power delivery is determined by the demands of the user's application.

8. The active respiratory filtration system of claim 1, further comprising a redundant member functionally incorporated to said active respiratory filtration system, wherein said redundant member is selected from the group consisting of a second air pump, a second rear filter, a second control system and any combination thereof.

9. The active respiratory filtration system of claim 1, wherein said air transport enclosure system is selected from the group consisting of a hose, a tube, a rectangular duct and any combination thereof.

10. An active respiratory filtration system for providing a hygienic barrier between a user and the user's proximate surroundings having a volume of unfiltered air, said active respiratory filtration system comprising a harness adapted to engage with the user's head, said harness comprising:
(a) a rear portion comprising a filtration system module attached thereon, said filtration system module further comprising:
(b) (i) an air pump for moving the volume of unfiltered air through a rear filter, so to produce a delivery of filtered air; and
(c) (ii) a control system functionally connected to said air pump for controlling said delivery of filtered air, said control system further comprising a power source for motivating said air pump; and
(d) (iii) an air transport enclosure system configured for directing flow of said delivery of filtered air exiting from said filtration system module; and
(e) a front portion, comprising a face mask attached thereon, said face mask configured from a filter material, said face mask comprising:
(f) (i) an inner volume and an outer surface; and
(g) (ii) at least one face mask connector disposed on said outer surface configured to fluidly engage with said air transport enclosure system, so to direct said delivery of filtered air from said filtration system module to said inner volume of said face mask,
wherein said face mask receives said delivery of filtered air so to produce a positive pressure environment within said inner volume of said face mask, thereby reducing the risk of environmental contamination via face mask gaps or defects.

11. The active respiratory filtration system of claim 10, wherein said face mask further comprises at least one check valve for enabling the unfiltered venting of the user's exhalation air from said inner volume of said face mask, thereby circumventing said filter material, resulting in a reduction in exhalation effort.

12. The active respiratory filtration system of claim 10, wherein said air transport enclosure system further comprises at least one check valve disposed therein, configured to prevent backflow of the user's exhalation air.

13. The active respiratory filtration system of claim 10, wherein said rear filter and said face mask is fabricated from a material selected from the group consisting of a pathogenic filtering material, a particulate contaminant filtering material, a HEPA certified material and any combination thereof.

14. The active respiratory filtration system of claim 10, wherein said air pump is disposed downstream of said rear filter, whereby said air pump receives said delivery of filtered air.

15. The active respiratory filtration system of claim 10, wherein said control system is configured to manage a power delivery to said air pump, wherein magnitude of said power delivery is determined by the demands of the user's application.

16. The active respiratory filtration system of claim 10, further comprising a redundant member functionally incorporated to said active respiratory filtration system, wherein said redundant member is selected from the group consisting of a second air pump, a second rear filter, a second control system and any combination thereof.

17. The active respiratory filtration system of claim 10, wherein said air transport enclosure system is selected from the group consisting of a hose, a tube, a rectangular duct and any combination thereof.
